(19) United States
(12) Patent Application Publication
(10) Pub. No.: US 2005/0202850 A1
(43) Pub. Date: Sep. 15, 2005

(54) Wireless telephone configured for prepaid use

(76) Inventor: Michael Kuty, Fredericksburg, VA (US)

Correspondence Address: SIMON, GALASSO & FRANTZ PLC., P.O. Box 26503, Austin, TX, 78755-0503, US

(21) Appl. No.: 10/840,103

(22) Filed: May 6, 2004

Related U.S. Application Data
(60) Provisional application No. 60/551,490, filed on Mar. 9, 2004.

(51) Int. Cl. H04M 11/00

(52) U.S. Cl. 455/565; 455/407

(57) ABSTRACT

A packaged wireless telephone comprises a wireless telephone, packaging, activation system access information and telephone activation information. The packaging has the wireless telephone packaged therein. The wireless telephone includes on-board circuitry configured to enable a predetermined amount of calling time. The activation system access information is provided on at least one of a component of the wireless telephone and the packaging. The telephone activation information is at least one of provided on the packaging, provided on documentation within the packaging, provided on a component of the wireless telephone and embedded in the on-board circuitry.

### CROSS REFERENCE TO RELATED APPLICATIONS

This application claims priority to co-pending U.S. Provisional Patent Application having Ser. No. 60/551,490 filed Mar. 9, 2004 entitled “The Easy Cell”, having a common applicant herewith.

### FIELD OF THE DISCLOSURE

The disclosures made herein relate generally to wireless telephones and, more particularly, to wireless telephones configured for use with pre-paid calling plans.

### BACKGROUND

Wireless phones (e.g., cell telephones, satellite telephones and the other types of paid service wireless telephones) have become a globally accepted and desirable means for personal and business communication. They provide their owners with a communication means that is convenient, mobile, relatively inexpensive and relatively reliable. Furthermore, wireless phones provide their owners with a means of communication in emergency situations when a landline is not readily available or practical (e.g., power outages, remote locations, when travelling, etc).

Wireless phones and their associated conventional calling plan approaches are known to have one or more limitations that adversely affect their effectiveness, desirability and/or practicality. One limitation is that conventional calling plan approaches typically require a prospective service subscriber to have established credit and/or good credit, which many prospective subscribers do not have. Another limitation is that conventional calling plan approaches often require a prospective subscriber to enter into a relatively long-term calling plan contract, which is often undesirable to prospective subscribers as it locks them into a particular carrier. Another limitation is that conventional calling plan approaches are not practical for a prospective subscriber who wants a wireless phone solely for emergency situations or for a special-use (e.g., a long driving excursion). Another limitation is that loss or theft of a wireless phone often requires the owner to pay for a new one, which can be a relatively substantial cash outlay. Still another limitation is that wireless phones, particularly relatively expensive versions, are popular targets for thieves.

Therefore, a wireless phone and associated prepaid calling plan approach that overcomes limitations associated with such conventional wireless phones and conventional wireless phone calling plan approaches would be useful and novel.

### SUMMARY OF THE DISCLOSURE

In one embodiment of the inventive disclosures made herein, a wireless telephone comprises on-board circuitry configured to enable a predetermined amount of calling time.

In another embodiment, a packaged wireless telephone comprises a wireless telephone, packaging, activation system access information and telephone activation information. The packaging has the wireless telephone packaged therein. The wireless telephone includes on-board circuitry configured to enable a predetermined amount of calling time. The activation system access information is provided on at least one of a component of the wireless telephone and the packaging. The telephone activation information is at least one of provided on the packaging, provided on documentation within the packaging, provided on a component of the wireless telephone and embedded in the on-board circuitry.

In still another embodiment, a method comprises configuring on-board circuitry of a wireless telephone to enable a predetermined amount of calling time, providing activation system access information, providing telephone activation information and enabling communication operation of the wireless telephone in response to the activation system receiving the telephone activation information. The activation system access information is provided on at least one of packaging having the on-board circuitry packaged therein, documentation within the packaging, the on-board circuitry and a surface of the wireless telephone. The telephone activation information is at least one of provided on the packaging, provided on the on-board circuitry, provided on a surface of the wireless telephone and embedded in the on-board circuitry.

Accordingly, it is a principal object of the inventive disclosures made herein to provide a novel and useful approach for configuring a wireless telephone for pre-paid use. Specifically, a wireless telephone in accordance with the inventive disclosures made herein is configured to allow an owner of the telephone to use the phone for a predetermined amount of time. In doing so, at least a portion of the limitations associated with conventional wireless phones and conventional wireless phone calling plan approaches are advantageously overcome.

It is another object of the inventive disclosures made herein for the on-board circuitry to include memory and for the memory to be configured to enable the predetermined amount of calling time.

It is another object of the inventive disclosures made herein for the activation system access information to be comprised by at least one system-scannable code and for the telephone activation information to be comprised by at least one system-scannable code.

It is another object of the inventive disclosures made herein for the telephone activation information to be embedded in the on-board circuitry and for the on-board circuitry to be configured for providing the telephone activation information to the activation system in response to the activation system being accessed using the activation system access information.

It is another object of the inventive disclosures made herein for the on-board circuitry to be comprised by a removable module and for the removable module to be selectively engagable with and disengagable with other onboard circuitry.

It is another object of the inventive disclosures made herein for enabling the communication operation to include scanning at least one system-scannable code for facilitating receiving the telephone activation information.

It is another object of the inventive disclosures made herein for scanning the at least one system-scannable to be performed by a point-of sale system for receiving payment for at least one of the on-board circuitry and the wireless telephone and for communicating the telephone activation information to the activation system.

It is another object of the inventive disclosures made herein for the activation system access information to include a telephone number, for the telephone activation information to include a human readable code and for enabling the communication operation to include calling the activation system using the telephone number and entering the human readable code for facilitating receiving the telephone activation information.

It is another object of the inventive disclosures made herein to provide for configuring the on-board circuitry with the telephone activation information such that the on-board circuitry is thereby capable of facilitating transmission of the telephone activation information for reception by the activation system.

These and other objects of the inventive disclosures made herein will become readily apparent upon further review of the following specification and associated drawings.

### BRIEF DESCRIPTION OF THE DRAWINGS

FIGS. 1A and 1B depict a wireless telephone in accordance with a first embodiment of the inventive disclosures made herein, which has fixed on-board circuitry configured for enabling a predetermined amount of calling time.

FIG. 2 depicts a wireless telephone in accordance with a second embodiment of the inventive disclosures made herein, which has on-board circuitry comprising a removable module configured for enabling a predetermined amount of calling time.

FIGS. 3A and 3B depict a packaged wireless telephone in accordance with an embodiment of the inventive disclosures made herein.

FIG. 4 depicts an apparatus in accordance with an embodiment of the inventive disclosures made herein, which is configured for and capable of supporting a method for providing pre-paid calling service using a telephone configuration as disclosed herein.

### DETAILED DESCRIPTION OF THE DRAWINGS

Wireless phones in accordance with embodiments of the inventive disclosures made herein provide an innovative alternative to conventional wireless phones. Specifically, such wireless phones are configured for allowing the owner to use the wireless phone for a specific number of minutes. In this manner, the need to commit to a contracted calling plan is eliminated. Furthermore, such a phone is relatively simple to use.

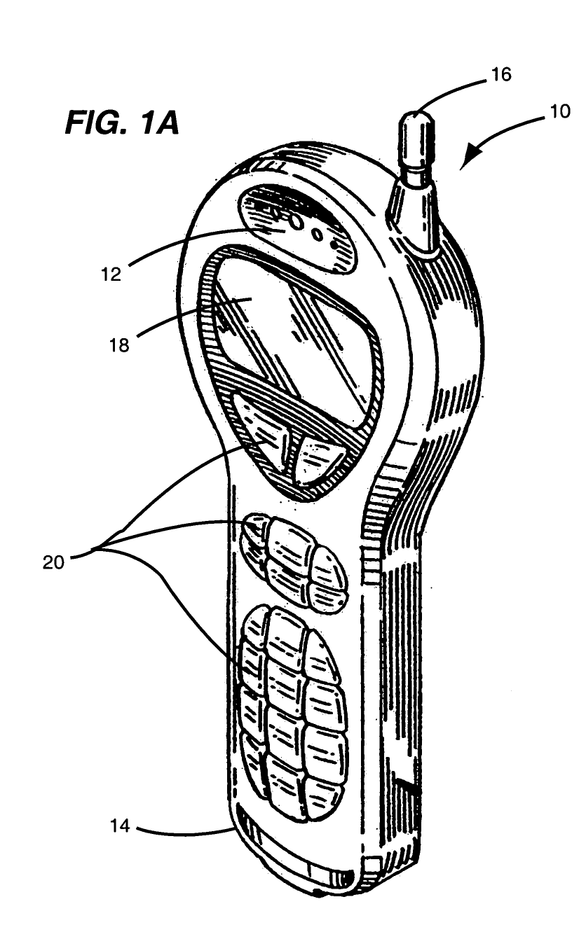

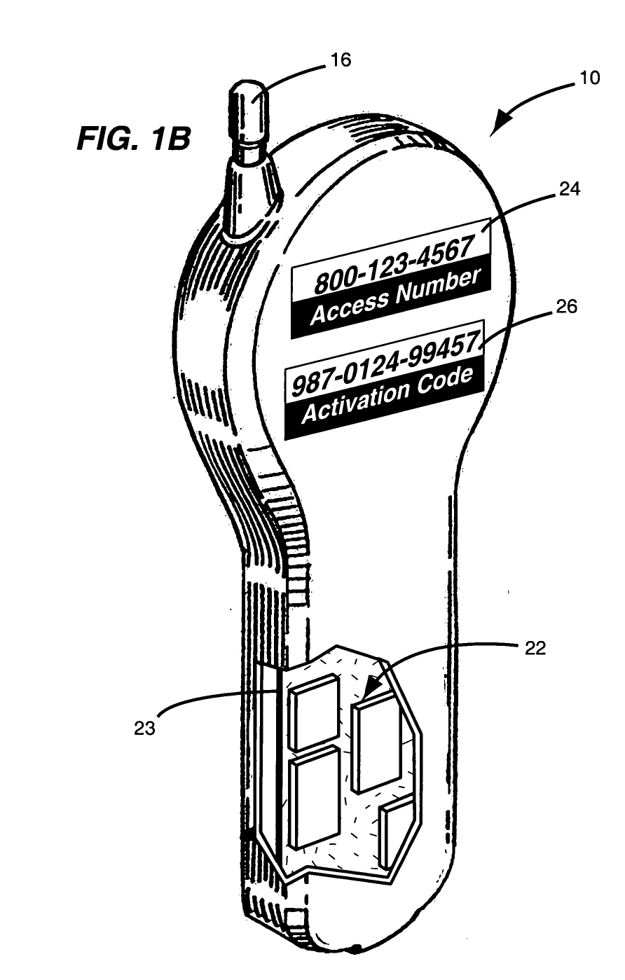

Referring now to FIGS. 1A and 1B, a wireless telephone 10 in accordance with a first embodiment of the inventive disclosures made herein is depicted. FIG. 1A depicts a front view of the wireless telephone 10 and FIG. 1B depicts a rear view of the wireless telephone 10. The wireless telephone 10 includes audio output components (generally denoted at numeral 12), audio input components (generally denoted at numeral 14), an antenna 16, visual display components (generally denoted at numeral 18), a set of control buttons 20 and on-board circuitry 22 configured for enabling a predetermined amount of calling time. In one embodiment, the on-board circuitry 22 includes a circuit substrate 23 having components (e.g., memory, a processor, etc) mounted thereon. The wireless telephone 10 further includes a plurality of components not specifically shown. Examples of such components include components configured for providing power supply functionality, components configured for providing signal transceiver functionality, components configured for providing information processing functionality and components configured for providing call time timing functionality.

In one embodiment, the on-board circuitry 22 includes memory pre-programmed with a designated amount of activation time (e.g., a designated number of minutes) that can be used by the owner of the wireless phone. For example, such amount of time may range from as little as about 10 minutes to more than 1000 minutes. The specific amount of time is not a limiting factor of the disclosures made herein.

The wireless telephone 10 further comprises activation system access information 24 thereon and telephone activation information 26 thereon. As depicted, the activation system access information 24 includes a human readable (e.g., printed) phone number and the telephone activation information 26 includes a human readable (e.g., printed) activation code. In another embodiment (not shown), the activation system access information 24 is comprised by at least one system-scannable code (e.g., a barcode) and the telephone activation information 26 is comprised by at least one system-scannable code (e.g., a barcode). It is contemplated that the activation system access information 24 and the telephone activation information 26 are comprised by a composite system-scannable code. In still another embodiment (not shown), the telephone activation information 26 is embedded in the on-board circuitry. In this manner, the on-board circuitry is configured for providing the telephone activation information to the activation system in response to the activation system being accessed using the wireless telephone 10.

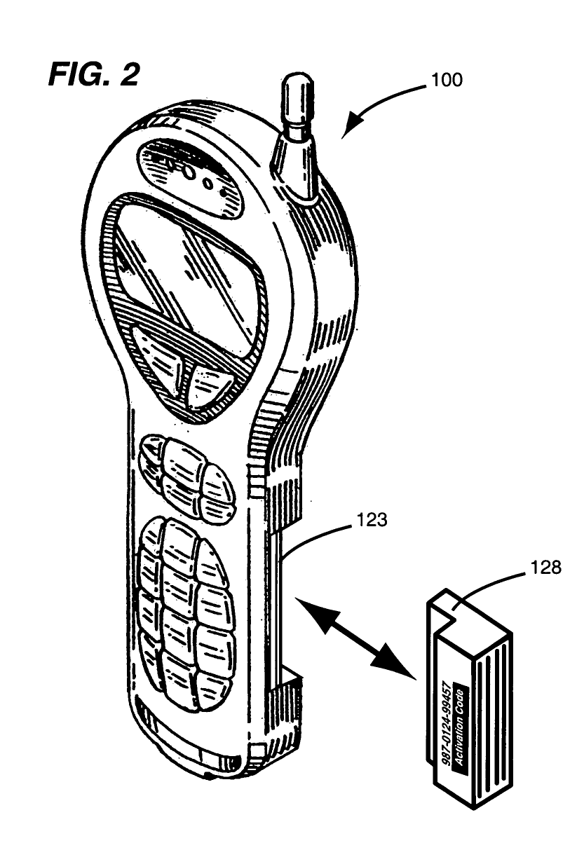

Referring now to FIG. 2, a wireless telephone 100 in accordance with a second embodiment of the inventive disclosures made herein is configured with a removable module 128. From a call time functionality perspective, the wireless telephone 100 depicted in FIG. 2 operates substantially the same as the wireless telephone 10 depicted in FIGS. 1A and 1B. The removable module 128 is selectively engagable and disengagable with at least one circuitry components of a circuit substrate 123 mounted on a housing of the wireless telephone 100. The removable module 128 and the at least one component on the circuitry substrate 123 jointly define on-board circuitry of the wireless telephone 100. Accordingly, it is disclosed herein that the removable module 128 is comprised by on-board circuitry configured for enabling a predetermined amount of calling time.

It is contemplated and disclosed herein that, once the predetermined amount of calling time is depleted, the removable module 128 is either replaced with a new removable module or it is replenished with an additional predetermined amount of calling time. Accordingly, in one embodiment of the inventive disclosures made herein, removable modules similar to the removable module 128 are sold as packaged items, which include corresponding activation information provided on at least one of the packaging, the removable module and documentation within the packaging.

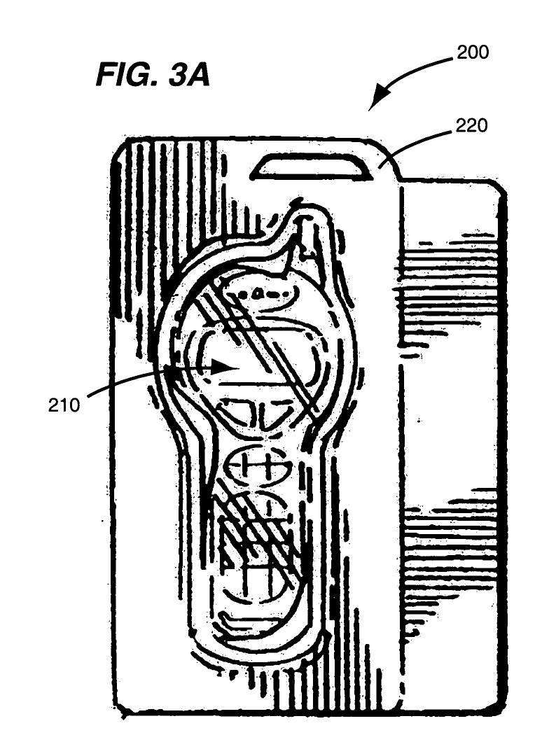

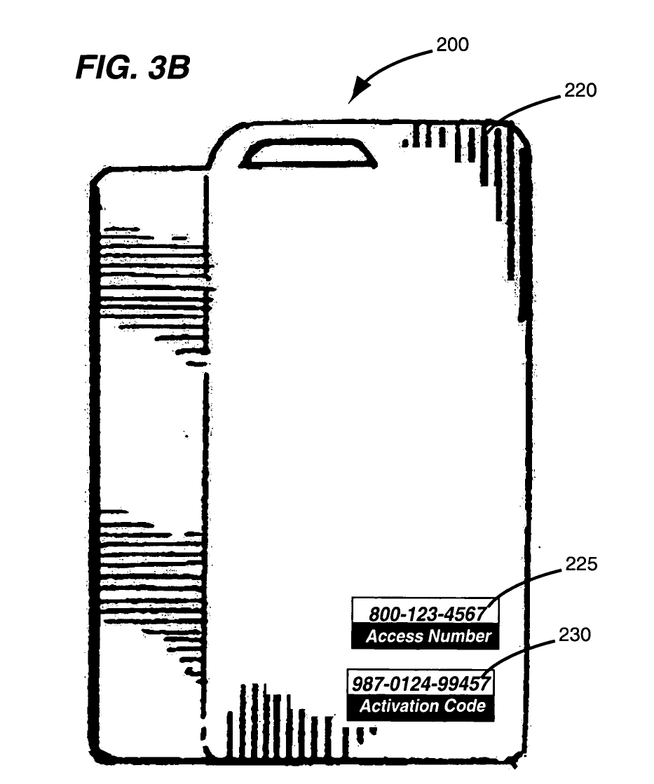

FIGS. 3A and 3B depict a packaged wireless telephone 200 in accordance with an embodiment of the inventive disclosures made herein. The packaged wireless telephone 200 comprises a wireless telephone 210, packaging 220, activation system access information 225 and telephone activation information 230. The packaging 220 has the wireless telephone 210 packaged therein. The wireless telephone 210 includes on-board circuitry configured to enable a predetermined amount of calling time. The activation system access information 225 is provided on at least one of a component of the wireless telephone 210 and, as depicted, the packaging 220. The telephone activation information 230 is at least one of provided on the packaging 220, provided on documentation within the packaging, provided on a component of the wireless telephone 210 (e.g., a telephone housing, a removable module, etc) and embedded in on-board circuitry of the wireless telephone 210.

In one embodiment, the activation system access information 225 is comprised by at least one system-scannable code and the telephone activation information 230 is comprised by at least one system-scannable code. In one embodiment of the wireless telephone 210, the on-board circuitry is comprised by a removable module that is configured for enabling a predetermined amount of calling time and configured for being selectively engagable with and disengagable with other onboard circuitry.

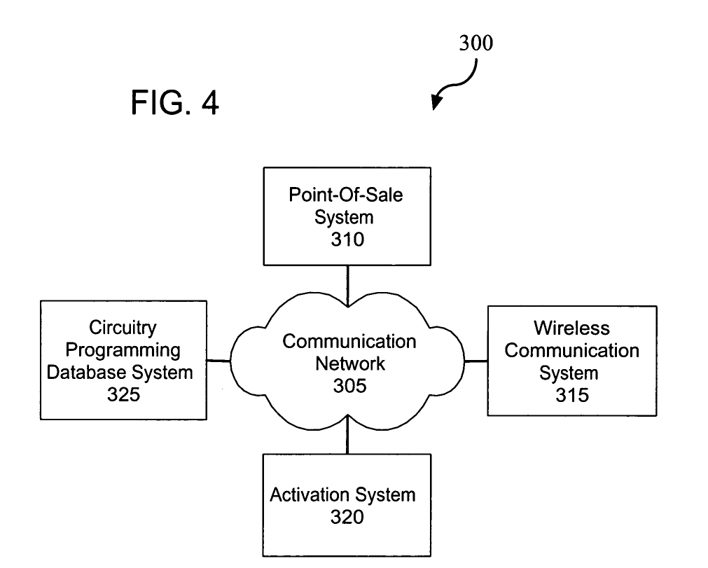

FIG. 4 depicts an apparatus 300 in accordance with an embodiment of the inventive disclosures made herein. The system 300 includes a communication network 305 (e.g., a telecommunication system and/or data network system), a point of sale system 310, a wireless communication system 315 (e.g., the system of a wireless service provider), an activation system 320 and a circuitry programming database system 325 (i.e., a system configured for programming the on-board circuitry with a predetermined amount of calling time). It is contemplated herein that the activation system 320 may be comprised by the wireless communication system 315. It is contemplated herein that the circuitry programming database system may be that of a circuitry manufacturer, a wireless carrier (e.g., comprised by the wireless communication system 315) or a third party service provider and comprised by a respective system thereof.

The apparatus 300 is configured for and capable of supporting a method for providing pre-paid calling service using a wireless telephone configuration as disclosed herein. The method comprises configuring on-board circuitry of a wireless telephone to enable a predetermined amount of calling time, providing activation system access information, providing telephone activation information and enabling communication operation of the wireless telephone in response to the activation system receiving the telephone activation information. For enabling authorized activation of a wireless telephone in accordance with an embodiment of the disclosures made herein, activation system access information and telephone activation information are shared between at least one of the point-of-sale system 310, the wireless communication system 315 and the activation system 320.

In one embodiment of such a method, the activation system access information is comprised by at least one system-scannable code, the telephone activation information is comprised by at least one system-scannable code and enabling the communication operation includes scanning the at least one system-scannable code for facilitating receiving the telephone activation information by the activation system 320. The scanning is performed by the point-of sale system 310 for receiving payment for the on-board circuitry and/or the wireless telephone and for communicating the corresponding telephone activation information to the activation system 320. In another embodiment, the activation system access information includes a telephone number, the telephone activation information includes a human readable code and enabling the communication operation includes calling the activation system 320 using the telephone number and entering the human readable code for facilitating receiving the telephone activation information by the activation system 320.

Thus, in operation, a person purchases a wireless phone in accordance with an embodiment of the disclosures made herein. An activation code is provided on a component of the wireless phone, packaging in which the wireless telephone is sold, or embedded within on-board circuitry of the wireless telephone. Activation of the wireless phone includes accessing an activation system and providing the activation code when prompted. In one example, the activation system is accessed in response to scanning a UPC code during purchase of the phone and the system prompts the POS system to then scan a barcode corresponding to the activation code. It is contemplated that the barcode may include the telephone activation code, thus precluding the need to the prompt and additional scan. In another example, an activation system access phone number is provided for accessing the activation system and the owner of the wireless telephone is provided with a human readable activation code, which the owner of the wireless telephone manually enters when prompted after calling the activation system access phone number.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical, chemical and electrical changes may be made without departing from the spirit or scope of the invention. For example, functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A wireless telephone, comprising:
on-board circuitry configured to enable a predetermined amount of calling time.

2. The wireless telephone of claim 1 wherein:
said on-board circuitry includes memory; and
said memory is configured to enable the predetermined amount of calling time.

3. The wireless telephone of claim 1, further comprising:
activation system access information; and
telephone activation information.

4. The wireless telephone of claim 3 wherein:
said activation system access information is comprised by at least one system-scannable code; and
said telephone activation information is comprised by at least one system-scannable code.

5. The wireless telephone of claim 1, further comprising:
activation system access information; and
telephone activation information embedded in said on-board circuitry, wherein said on-board circuitry is configured for providing said telephone activation information to said activation system in response to said activation system being accessed using said activation system access information.

6. The wireless telephone of claim 1, further comprising:
telephone activation information embedded in said on-board circuitry:
wherein said on-board circuitry is configured for providing said telephone activation information to said activation system in response to said activation system being accessed using the wireless telephone;
wherein said on-board circuitry includes memory; and
wherein said memory is configured to enable the predetermined amount of calling time.

7. The wireless telephone of claim 6 wherein:
said activation system access information is comprised by at least one system-scannable code; and
said telephone activation information is comprised by at least one system-scannable code.

8. The wireless telephone of claim 1 wherein:
said on-board circuitry is comprised by a removable module; and
the removable module is selectively engagable with and disengagable with other onboard circuitry.

9. The wireless telephone of claim 8, further comprising:
activation system access information; and
telephone activation information embedded in said on-board circuitry, wherein said on-board circuitry is configured for providing said telephone activation information to said activation system in response to said activation system being accessed from the wireless telephone using said activation system access information.

10. The wireless telephone of claim 9 wherein:
said on-board circuitry includes memory; and
said memory is configured to enable the predetermined amount of calling time.

11. A packaged wireless telephone, comprising:
a wireless telephone including on-board circuitry configured to enable a predetermined amount of calling time;
packaging having the wireless telephone packaged therein;
activation system access information on at least one of a component of the wireless telephone and said packaging; and
at least one of telephone activation information on said packaging, telephone activation information on documentation within said packaging, telephone activation information on a component of the wireless telephone and telephone activation information embedded in said on-board circuitry.

12. The wireless telephone of claim 11 wherein:
said activation system access information is comprised by at least one system-scannable code; and
said telephone activation information is comprised by at least one system-scannable code.

13. The wireless telephone of claim 11 wherein:
said on-board circuitry is comprised by a removable module; and
the removable module is selectively engagable with and disengagable with other onboard circuitry.

14. The wireless telephone of claim 11 wherein said on-board circuitry is configured for providing said telephone activation information to said activation system in response to said activation system being accessed from the wireless telephone using said activation system access information.

15. A method, comprising:
configuring on-board circuitry of a wireless telephone to enable a predetermined amount of calling time;
providing activation system access information on at least one of packaging having said on-board circuitry packaged therein, documentation within said packaging, said on-board circuitry and a surface of the wireless telephone;
providing telephone activation information, wherein said telephone activation information is at least one of provided on said packaging, provided on said on-board circuitry, provided on a surface of the wireless telephone and embedded in said on-board circuitry; and
enabling communication operation of the wireless telephone in response to said activation system receiving said telephone activation information.

16. The method of claim 15 wherein:
said activation system access information is comprised by at least one system-scannable code;
said telephone activation information is comprised by at least one system-scannable code;
enabling said communication operation includes scanning said at least one system-scannable code for facilitating said receiving telephone activation information.

17. The method of claim 15 wherein said scanning is performed by a point-of sale system for:
receiving payment for at least one of said on-board circuitry and the wireless telephone; and
communicating said telephone activation information to said activation system.

18. The method of claim 15 wherein:
said activation system access information includes a telephone number;
said telephone activation information includes a human readable code;
enabling said communication operation includes calling said activation system using said telephone number and entering said human readable code for facilitating said receiving telephone activation information.

19. The method of claim 15 wherein
said on-board circuitry is comprised by a removable module; and
the removable module is selectively engagable with and disengagable with other onboard circuitry.

20. The method of claim 15 further comprising:
configuring said on-board circuitry with said telephone activation information, wherein said on-board circuitry is thereby capable of facilitating transmission of said telephone activation information for reception by said activation system.
